(19) United States
(12) Patent Application Publication
(10) Pub. No.: US 2003/0204408 A1
(43) Pub. Date: Oct. 30, 2003

(54) Method and system for optimal product bundling and design

(76) Inventors: Kemal Guler, Cupertino, CA (US); Tongwei Liu, Brooklyn, NY (US); Hsiu-Khuern Tang, Menlo Park, CA (US)

Correspondence Address: HEWLETT-PACKARD COMPANY, Intellectual Property Administration, P.O. Box 272400, Fort Collins, CO, 80527-2400, US

(21) Appl. No.: 10/136,204

(22) Filed: Apr. 30, 2002

(51) Int. Cl. G06F 17/60

(52) U.S. Cl. 705/1

(57) ABSTRACT

An apparatus and a method for extracting an underlying demand system for optimal product bundling and design. User input is received that indicates items for which a demand system is to be determined. Auction participants are selected. The structure of the auction is configured for determining demand complementarities of the items to be auctioned. At least one auction is then conducted using the configured structure so as to obtain bid data for each of the items that are auctioned. The bid data is then analyzed to determine an estimate of a demand system for the products.

### TECHNICAL FIELD

The present invention relates to the field of product pricing. More specifically, the present invention relates to a method and apparatus for estimating a demand system for products.

### BACKGROUND ART

It is important to accurately estimate demand for products that have demand complementarities to enable maximization of revenue and maximization of profit. Examples of products having demand complementarities include complimentary products that can be sold as a bundle and different configurations of a product. For complimentary products that can be bundled, the value of the bundle to a consumer is not necessarily the sum of the value of the bundled products. Similarly for different configurations of a product, the value of each configuration is not necessarily the sum of the value of each of the attributes in the configuration.

Designing an appropriate product bundling strategy requires information on the structure of demand complementarities among complementary products. Similarly, determining the optimal configuration of a product requires information on the structure of demand complementarities among various attributes that constitute a product.

Whether complementary products (e.g., a personal computer and a printer) should be sold separately or as a bundle, and the prices one should charge for each item sold separately and sold as part of a bundle depends on the responses of potential customers. Designing an appropriate product bundling strategy requires information on the structure of demand complementarities among products.

Similarly, determining the optimal configuration of a product requires information on the structure of demand complementarities among various attributes that constitute the product. For example, various product attributes (e.g., CPU speeds, storage sizes, RAM sizes etc.) can be combined to configure a personal computer. The seller needs a reliable estimate of potential customers' responses to decide the set of configurations to be made available in the market, the prices of these configurations as well as availability of various possible upgrades and the prices thereof.

Estimation of demand systems with complementarities based on econometric analysis of historical market price and volume data is typically not reliable because of limited price variation in available data sets and because strong modeling assumptions are needed to identify and estimate the underlying demand system. Moreover, historical data is of limited value because the range of observed variation of product and attribute combinations and of prices in typical data sets is often too narrow to allow reliable extrapolation about the structure of demand.

Furthermore, field test-marketing techniques are too costly to explore a reasonable range of product and attribute combinations and potential prices. They are also of limited value because of limited experimental control.

In principle, data on willingness-to-pay by customers can be collected by survey methods. However, survey responses are known to be of limited reliability because of lack of commitment to buy and pay on the part of the respondents. Therefore, these methods do not induce participants to report their true valuations.

Therefore, prior art methods for the estimation of demand systems are unreliable in that the relied upon historical market price and volume data are insufficient to truly estimate demand system structure. Moreover, prior art attempts to provide a more complete set of market and volume data for the estimation of demand system structure, such as, surveys and field marketing techniques, has heretofore proved too costly or to provide skewed and faulty results resulting in inadequate estimates of demand system structures.

### DISCLOSURE OF THE INVENTION

A method and system for determining an estimate of a demand system is disclosed. User input is received that indicates items for which the demand system is to be determined. Auction participants are selected from a pool of available auction participants. The auction structure is configured for determining demand complementarities of each of the items to be auctioned. At least one auction is then conducted using the selected auction participants and using the configured structure so as to obtain bid data for each of the items that are auctioned. The bid data is then analyzed to determine an estimate of the demand system for the items.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a block diagram that illustrates participants for conducting auctions that are analyzed for determining a demand system in accordance with an embodiment of the present invention.

FIG. 2 is a diagram showing participants communicating with a computing device via the Internet and a user communicating with the computing device in accordance with an embodiment of the present invention.

FIG. 3 illustrates a method for determining an estimation of a demand system that can be used for determining a profit-maximizing portfolio of products and the attribute content of each product, and that can be used for determining the set of products and bundle prices that maximizes expected profit in accordance with one embodiment of the present invention.

FIG. 4 illustrates a graph that indicates outcome as a function of price and valuation for a product A, a product B, and a bundle AB in accordance with one embodiment of the present invention.

FIG. 5 illustrates a method for determining an estimation of a demand system that does not include conducting an auction in accordance with one embodiment of the present invention.

### BEST MODES FOR CARRYING OUT THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

Accordingly, the present invention provides method and system for extracting the underlying demand system for a set of products and for product attributes in order for determining optimal product bundling and design. The estimated demand system and user provided production cost information can then used to formulate an estimate profit function. Advantages of the present invention include the ability to generate observations needed to identify and estimate the underlying demand system rather than relying on inconsistent and incomplete historical market price and volume data.

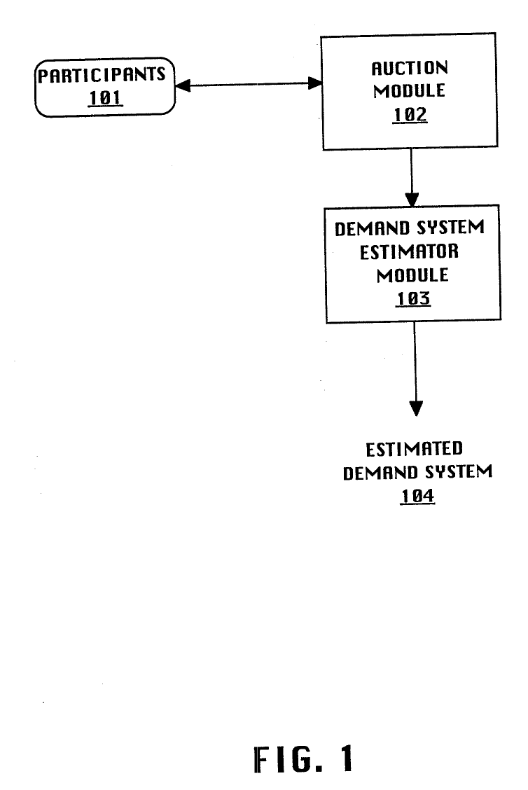

FIG. 1 illustrates an embodiment in which participants 101 are used for conducting an auction in auction module 102. The structure of the auction as implemented by auction module 102 is configured for the purpose of nonparametric estimation of demand complementarities. The auction module 102 outputs auction data.

The auction data from the auction module 102 is analyzed as shown in FIG. 1 by a demand system estimator module 103 to estimate the underlying demand system for a set of products and for product attributes. An output of the estimator module 103 is the estimated demand system 104. The estimated demand system 104 includes products and bundles of products when the auction as implemented in auction module 102 also includes the products and corresponding bundles of products. In addition, when the auction as implemented by auction module 102 includes products having different product attributes, a demand system is obtained that indicates demand for those product attributes.

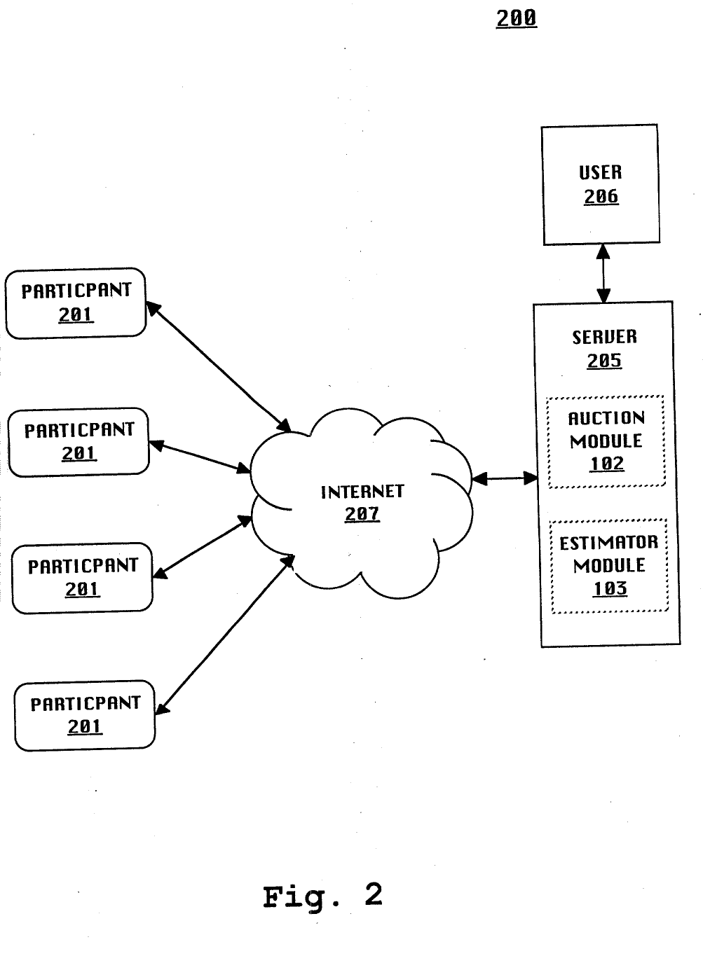

In the embodiment shown in FIG. 2, the auction is held electronically via communication over the Internet. More particularly, individual participants, shown as participants 201-204 communicate with a server 205 for submitting bids during the auction. In the present embodiment this communication is over the Internet 207. However, alternatively, communications could be coupled over pathways other than the Internet such as, for example, using wireless communication methods, telephone, etc.

In another embodiment, server 205 includes the auction module 102 of FIG. 2, used for conducting and providing the auction site. Also, the sever 205 includes the demand system estimator module 103, for estimating the underlying demand system 104.

Still referring to FIG. 2, a user 206 is shown to be directly communicating with server 205. However, user 206 could also be communicatively coupled with server 205 using the Internet 207.

Continuing with FIG. 2, in one embodiment server 205 includes a software program that is operable on a computer system. This software program is operable to provide an auction site. In one embodiment the computer system includes a processor coupled to a bus and memory storage coupled to the bus. The memory storage can be volatile or non-volatile and can include removable storage media. The computer can also include a display, provision for data input and output, etc.

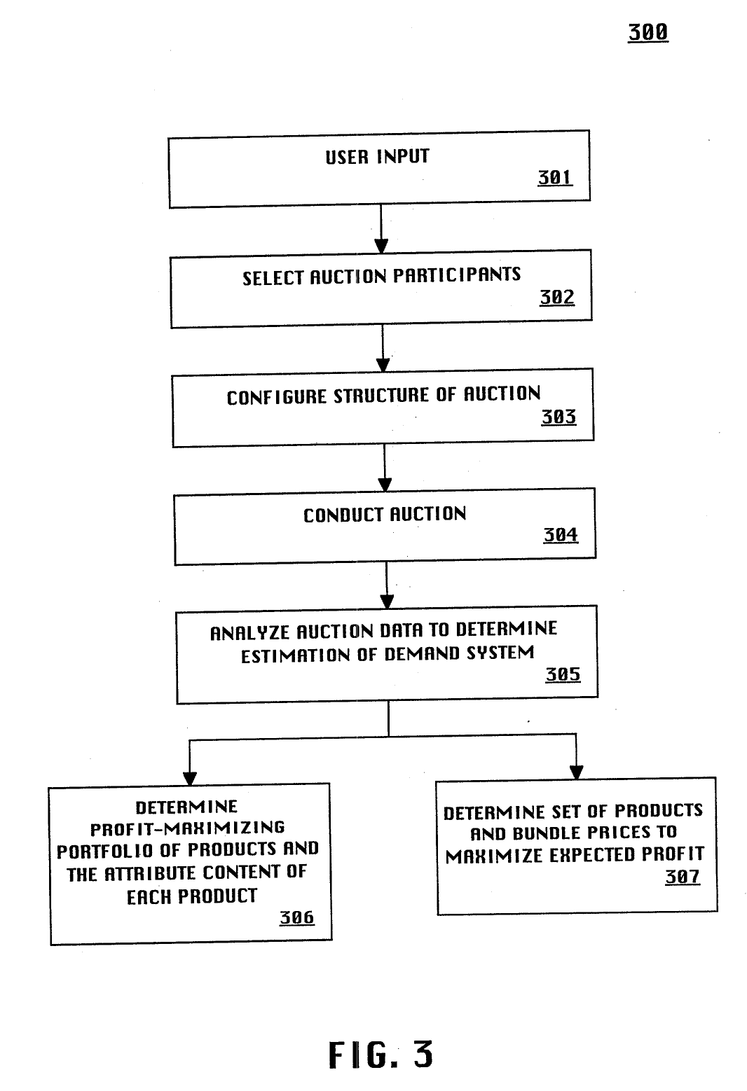

FIG. 3 is a flow diagram of the steps in a method 300 for determining a demand system for products. The determined demand system can then be used for determining a profit-maximizing portfolio of products and the attribute content of each product. Also, the determined demand system can be used to determine the set of products and bundle prices that maximize expected profit.

As shown by step 301 of FIG. 3, user input is received. In one embodiment, user input includes information identifying each product (product identification information) and the cost of each product (product cost). The user also indicates constraints and other data that relate to the products and that relates to the auction to be conducted. In the embodiment shown in FIG. 2, user input is coupled from user 206 (e.g., by entry of data into a computer) to server 205. In one embodiment, web pages are received from server 205. The required information is entered on the received web pages and the completed web pages are sent back to server 205.

In the one embodiment the user specifies the target market in the form of observable buyer characteristics. The user also provides operational information on terms and conditions, such as payment terms, delivery options, etc. that are common to all of the auctions that are to be conducted.

In one embodiment, the user also can specify constraints for certain decision variables (e.g., the maximum number of auctions, the maximum number of bidders per auction, the maximum number of units per auction, maximum reserve price in each auction and minimum reserve price in each auction.

For example, the user can input item A which is a personal computer, item B which is a printer and the bundle AB which includes both the personal computer and the printer. Thus, the items A and B represent the basic products, here a personal computer and a printer, respectively; and the item AB represents the bundle that contains a personal computer and a printer. In this example and in following examples, items that represent basic products are represented by single letters (A, B, C etc.) while items that represent bundles are denoted by a combination of letters that correspond to the items in the bundle.

As shown by step 302 of FIG. 3, auction participants are selected. In the embodiment shown in FIG. 2, auction participants are selected automatically by server 205 based on input received in step 301 of FIG. 3 and based on the pool of auction participants that is currently available.

The participants are selected from a pool of subjects who have previously agreed to participate in test-marketing programs. In the present embodiment the pool of participants is a representative sample of the potential buyers based on user input from step 301 and based on statistical sampling principles.

Referring still to FIG. 3, the structure of the auction is configured as shown in step 303. The auction structure is configured for the specific purpose of nonparametric estimation of demand complementarities. In the present embodiment configuration of the auction includes the selection of auction rules. In one embodiment, auction rules include the auction format to be used; the number of auctions to be conducted; the reserve prices in the auctions to be conducted; the number of units available in each auction to be conducted; the set of participants in each auction to be conducted; the timing and duration of each action to be conducted; and the set of products available in each auction to be conducted.

In one embodiment the auction is structured for nonparametric estimation of the demand system for the products or attributes under investigation. In the present invention the term “nonparametric” includes any method that does not rely on strong a priori assumptions regarding the demand structure. In one embodiment the selection of products and/or product attributes and quantities offered are determined with the objective of efficient demand estimation for obtaining an estimate of demand complementarities. The term “demand complementarities” in the present application refers to elements of demand that are related in such a way that the demand elements can not be added for determining demand of the system. In one embodiment the auction is configured so as to elicit valuations for all relevant components and bundles simultaneously. Thereby, strong assumptions about behavior in auctions are not required in order to make inferences about bidder valuations.

In the present embodiment, the user-input constraints and other data entered in step 301 of FIG. 3 are used in the determination of the structure of the auction. In one embodiment, server 205 of FIG. 2 is operable to automatically determine the structure of the auction by generating auction rules. However, alternatively, the structure of the auction can be manually determined.

The auction format of the present embodiment is a Vickrey auction. The bidding decisions in Vickrey auctions are such that every participant reveals their true willingness to pay as a dominant strategy, regardless of how rival bidders behave. In the present embodiment, a multi-unit version of the Vickrey auction, which is a “price equals highest rejected bid” version, is used. In the multi-unit Vickrey auction, the method of inducing “truth telling” is to require that the price paid by the bidder be equal to the price that would clear the market if this bidder's demand were to be removed from the market. This eliminates the situation in which buyers wishing to buy more than one unit might be tempted to misrepresent their demand if all available units were to be sold at a uniform price equal to the highest rejected bid.

In one embodiment, a fixed number of units are sold through a sealed-bid Vickrey auction among a fixed number of invited participants. Information about the item for sale, auction rules, the number of units for sale, the number of invited bidders, reserve price, acceptable bid levels, starting and ending time of the auction are announced to the invited bidders both in an e-mail invitation and on the auction site (e.g., the auction site generated by server 205 of FIG. 2). One auction rule specifies the number of units of each item that is to be sold through the auction, indicated by the variable Q.

As shown by step 304 of FIG. 3, an auction is held. In one embodiment, the auction is held electronically through communication between server 205 of FIG. 2 and participants 201-204. Alternatively, the auction is a live-auction conducted at a convenient location or is held using some other communication mechanism such as, for example via telephone bids, etc.

In one embodiment, the auction is conducted by announcing a set of available items (menu items) to the participants (e.g., via email). The set of available items is indicated by the variable “J.” In the example in which a computer, a printer and a computer and printer bundle are to be auctioned, this gives J={A, B, AB}.

Each participant is instructed to submit a vector of bids that contains a bid for each of the menu items. In the present example in which the menu includes two basic products, A and B, and the bundle AB, each participant submits three numbers V_{A}, V_{B} and V_{AB}. The bid vector submitted by bidder i is denoted (V_{iA}, V_{iB}, V_{iAB}).

The received auction data is analyzed as shown by step 305 of FIG. 3 for determining an estimation of the demand system. In the present embodiment, for each item, submitted bids are ordered in descending order. The highest Q bidders for each item are the provisional winners. Let W_{A}, W_{B} and W_{AB} denote the set of provisional winners, i.e., the bidders whose bids are among the Q highest bids, for items A, B, and AB, respectively.

The price of item A, represented by the variable P_{A}, is set equal to the Q+1^{st} highest bid among all the bids submitted for item A. Similarly, the price of item B, represented by the variable P_{B}, is set equal to the Q+1^{st} highest bid among all the bids submitted for item for item B. Similarly, the price of item AB, represented by the variable P_{AB}, is set equal to the Q+1^{st} highest bid among all the bids submitted for item AB.

The items provisionally won by each bidder are determined. For bidder i, the variable J(i) denotes the set of items j in J such that i is a member of Wⱼ, the set of provisional winners of item j.

In one embodiment, for each bidder i the item(s) won by bidder i is determined by performing the following calculation: K(i)=Item awarded to bidder i=Arg max_{(j in J(i))} {Vᵢⱼ−Pⱼ} in which the price paid by each winning bidder i is P_{K(i)}.

Though the auction of step 304 is discussed above as being a single auction, it is appreciated that multiple auctions could also be used.

As shown by step 305, the bid data from the auction is analyzed to determine an estimation of the demand system for the auctioned products. In the present embodiment, the bid data from the auction is analyzed to determine a nonparametric estimation of the demand system for the auctioned products. However, nonparametric methods could also be used. In one embodiment, server 205 analyzes all received bid data and automatically determines the nonparametric estimate of the demand system.

In one embodiment, because the structure of the auction of the present invention uses a Vickrey auction, the method and apparatus of the present invention induces each bidder to submit his valuation vector as his bid. Also, because the auction is configured for nonparametric estimation of a demand system for the products or attributes of interest, the vectors of the winning bidders accurately reflect a demand system for the auctioned products and/or attributes. In one embodiment an accurate estimation of the demand system is achieved by mapping the observed bids (true valuations) with the observable characteristics of the buyers (those participants who are winners). Also, by eliciting valuations for all the relevant components simultaneously, strong assumptions on the relationship between component valuations and valuations for bundles is avoided.

Continuing with step 305 of FIG. 3, each potential customer has a set of characteristics represented by a vector X. In principle, part of this information is observable by the analyst if one is willing to incur the associated cost, and part is inherently unobservable. The vector of characteristics X is partitioned into observable, Y, and unobservable, Z, components. Information represented by the vector Y may include customers' demographics and other information that can be collected via questionnaires. Typically, more information is collected during a test-marketing and demand estimation campaign than is available during a regular period. Under suitable assumptions, estimated distribution of these random variables from data collected during a test-marketing campaign can be used to obtain unconditional distributions of the relevant variables. If the both Y and Z are observed during the study period, then together with the elicited valuations gives a vector (V, Y, Z) on a customer. Then the decision problem (e.g., for pricing) in the regular marketing stage is one of unconditional expectation of the profit function as a function of control variables and the observables. The data collected in the test-marketing stage allows one to get the joint distribution of the vector (V, Y, Z) as well as the marginal distributions of both (Y,Z) and Z. Hence, both the conditional distribution of (V, Y|Z) and the marginal distribution of (V,Y) can be obtained.

For an auction with n participants, a sample of size n is generated on the vector (V, Y). This sample is then processed using conventional statistical methods to obtain a non-parametric estimate of the joint distribution of the variables involved. Denote this estimated joint distribution by F(V, Y). An exemplary method for determining the joint distribution of the variables is described in more detail below.

In the formulation of the decision problems that follow, the joint distribution F(V, Y) is used to obtain estimates of the demand system. Given F(V, Y), a procedure is used to estimate the demand vector for the items as a function of the price vector and other observables. The joint distribution of valuations, V, and other customer characteristics, Y, can be used in two alternative ways depending on whether information contained in Y is observable at the marketing stage. If it is observable, then the conditional distribution F(V|Y)=F(V, Y)/F(Y) of V can be used to estimate the demand system. If Y is not observable in the marketing stage, then the marginal distribution F(V) of V, which is obtained by integrating Y out of F(V, Y) by well-known methods, is used to estimate the demand system.

Following is an example of a procedure for formulating a demand system based on the estimated distribution of valuations using the unconditional distribution of the valuations F(V). The distribution F(V) can then be used to obtain the probability of making a sale for each of the items offered given a price vector for the items offered.

The auction structure of the present invention allows for obtaining the valuations v_{A},v_{B} and v_{AB} for each participant. With these, statistical techniques are used to obtain estimates of the joint density and distribution functions of v_{A},v_{B} and v_{AB}. Nonparametric methods or parametric methods can be used. However, nonparametric methods are usually more robust and rely on fewer modeling assumptions while parametric methods require less data and are more suitable for estimating the joint distribution of a large number of variables.

The estimation can be performed under additional assumptions on the valuations. For example, assuming that v_{AB}=v_{A}+v_{B}, only the joint distribution of v_{A} and v_{B} is needed. Moreover, the joint distribution may be conditional on observed variables like the demographic information of the buyer.

The methods used in the present invention to generate data on valuations and to estimate the demand system generates a demand system that can be used in the formulation and optimization of various decision problems. One example, illustrated in step 307 provides optimal product bundling decisions by determining the profit-maximizing portfolio of products and the attribute content of each product. Another example, illustrated in step 308 provides for determining prices of components and bundles to maximize a seller's profit.

In one embodiment, method 300 of FIG. 3 is performed for determining demand complementarities of items having different configurations. In one embodiment, the auction is configured such that each attribute of interest is represented by at least one item. Thereby, the demand system for products having different product attributes can be determined. The decision variables are the attribute contents of various products the seller brings to the market. In this embodiment, the received bids are representative of valuations of the respective product attributes. Hence, the determined estimation of the demand system (step 305) indicates the demand for the various product attributes, allowing for determination of profit-maximizing portfolio of product attributes and the attribute content of each product attribute in step 306.

In one embodiment, the user can specify what type of analysis is to be performed using the estimated demand system. Step 306 and step 307 illustrate two exemplary types of analysis that can be performed. However, it is appreciated that many other types of analysis could also be performed using the estimated demand system obtained instep 305.

As shown by step 306 when the items include different configurations of products, the profit-maximizing portfolio of products and the attribute content of each product is determined as shown by step 306. In the present embodiment, the cost of each product entered in step 301 is used to determine the profit-maximizing portfolio of products and the attribute content of each product.

Following is an example illustrating an optimization of (p_{A}, p_{B}, p_{AB}). A seller has two types of products A and B, which he can sell individually and as a bundle to maximize the seller's expected revenue, expected profit, or some other criterion.

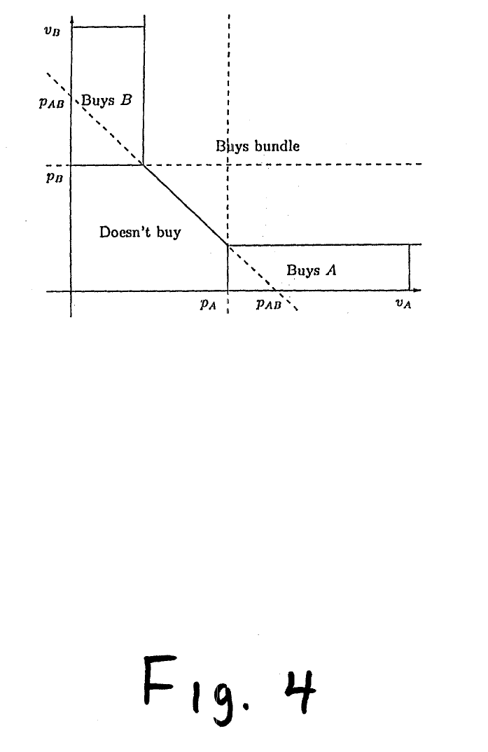

A buyer whose valuations are v_{A}, v_{B} and v_{AB}, respectively, will have a payoff of v_{I}−p_{I} if he buys item I (where I is A, B, or AB), and a payoff of 0 if he doesn't buy anything. Thus, he will choose to buy A, buy B, buy AB, or not buy anything depending on which choice maximizes his payoff. An example of the decisions a buyer can make as a function of his valuations is shown in FIG. 4 which assumes for simplicity that v_{AB}=v_{A}+v_{B}. Since the present invention gives an estimate for the joint distribution of (v_{A}, v_{B} and v_{AB}) among all the buyers, the proportions of buyers in each of the four categories can be determined. More specifically, the quantity demanded of item I is the probability of the event E_{I}, defined by the inequalities: v_{I}−p_{I}>max{vⱼ−pⱼ; J=A, B, or AB and J≠I}, v_{I}−p_{I}>0. The event E_{I}, is a region in (v_{A}, v_{B}, v_{AB})-space with linear boundaries that depend on the prices p_{A}, p_{B} and p_{AB}.

In one embodiment, the quantity demanded is estimated using the estimated joint distribution function F(v_{A}, v_{B}, v_{AB}) by the formula:

$$\begin{matrix}{q}_{I} := {q}_{I} ( {p}_{A} , {p}_{B} , {p}_{C} ) := demand of item I \\ := {\int }_{{E}_{I}}^{} ⅆ \hat{F} ( {v}_{A} , {v}_{B} , {v}_{AB} ) .\end{matrix}$$

The seller can estimate the expected revenue or profit from the buyers in each category. For example, the expected revenue is

$${\sum }_{I ∈ \{ A , B , AB \}}^{} {p}_{I} {q}_{I}$$

and the expected profit is

$${\sum }_{I ∈ \{ A , B , AB \}}^{} ( {p}_{I} - {c}_{I} ) {q}_{I}$$

where c_{I} is the cost of item I to the seller. These quantities depend on the prices p_{A}, p_{B} and p_{AB} which can be selected to maximize the criterion of interest to the seller.

Alternatively, when the items include bundles of products, the set of products and bundle prices that maximizes expected profit can be determined as shown by step 307. Following is an example of the process for determining the set of products and bundle prices that maximizes expected profit using the above example where a computer A, a computer printer B, and a bundle AB are auctioned.

For example, initially the computer is priced at $800, the printer is priced at $150 and the bundle is priced at $900. At these prices 20% of participants will buy a computer alone, 10% will buy a printer alone and 40% will buy the bundle. The remaining 30% will not buy anything. These proportions are obtained from the estimated distribution F. The expected revenue per person is thus 0.2×800 0.1×150+0.4×900=$535.

If the price of the bundle is increased from $900 to $930 while keeping the other prices fixed, some participants who would have bought the bundle at the previous prices are now going to buy only the computer or only the printer, or nothing at all. If, for example, the proportion of persons buying a computer alone and buying a printer alone increases by 10% each, to 30% and 20% respectively, while the proportion of people buying the bundle decreases by 25% to 15%, then the expected revenue per person becomes 0.3×800+0.2×150+0.15×930=$405. In this case, the first set of prices are better for the seller in terms of expected revenue. In the present embodiment, this method is used in an iterative process to determine the prices for each product and bundle that maximizes revenue.

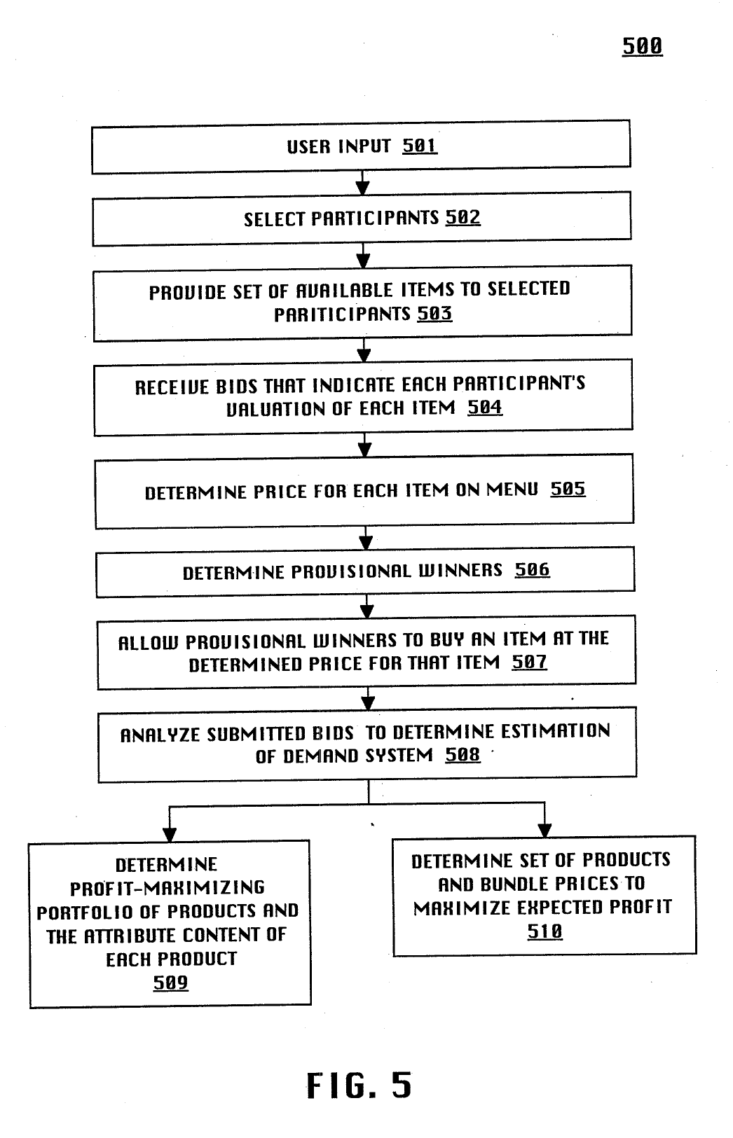

FIG. 5 illustrates a method 500 for determining an estimation of a demand system using an alternative valuation elicitation method that does not involve an auction.

User input is received as shown by step 501. In the present embodiment user input is received in the same manner as in step 301 of FIG. 3 and includes the items for which a demand system is to be determined. In one embodiment, user input includes information identifying each product (product identification information) and a range for possible valuations for each item. In the embodiment shown in FIG. 2, user input is coupled from user 206 (e.g., by entry of data into a computer) to server 205. In one embodiment, web pages are received from server 205. The required information is entered on the received web pages, and the completed web pages are sent back to server 205.

A set of participants is determined as shown by step 502. In the present embodiment, a set of participants is determined in the same manner as in step 302 of FIG. 3.

As shown by step 503, the set of available items is provided to the participants. In one embodiment, a menu of items is provided to each of the participants selected in step 501. The menu lists each of the items entered in step 301 for which a demand system is to be determined. In one embodiment, server 105 of FIG. 1 is used to send an email to each recipient that lists the menu of items.

Each bidder then submits a bid for each item on the menu of items as shown by step 504. The submitted bids provide a bid vector for each participant that indicates that participant's valuation. In the embodiment shown in FIG. 2, the menu of items is a form that is sent electronically to each participants 201-204. The form includes a blank space beside each item. Participants 201-204 fill out the form by indicating each participant's valuation for each item. The completed form is then electronically sent from each of participants 201-204 to server 105.

As shown by step 505, a price is determined for each of the items on the menu. In the present embodiment, a random provisional price is generated for each of the items on the menu. These random provisional prices can be generated by using any distribution function whose support contains the range of possible valuations for the items in the menu. For those items that represent a basic product, final price is set equal to the provisional price. For an item that represents a bundle of basic products, the final price is obtained as a function of the final prices of sub-bundles.

For example, for an exemplary set of products including three basic products, A, B and C, and all possible bundles that can be made (i.e., AB, AC, BC, ABC) with these three basic products so that J={A, B, C, AB, AC, BC, ABC}.

In one embodiment, for each item j in J, the system user inputs an interval, Sⱼ, that represents the range of possible valuations for item j. Then, for each item j in J, a random number uniformly distributed in the interval Sⱼ is generated. Denote this number Tⱼ. If item j is a basic product, i.e., j=A, B, or C, then the final price of j, denoted Pⱼ, is set equal to Tⱼ.

Continuing with step 505 of FIG. 5, the price for each bundle is the lesser of the sum of the randomly generated prices for each of the components in the bundle or a randomly generated number within the range of possible valuations for the bundled product. Thus, if item j is a bundle of two basic products, say A and B, then the final price of j is calculated as follows: P_{AB}=Min {T_{AB}, P_{A}+P_{B}}.

If the item j is bundle of three products, say A, B and C, then it can be viewed as a bundle of AB and C, or a bundle of AC and B, or as a bundle of BC and A. The final prices of the sub-bundles that comprise ABC are known from the previous step. The final price of ABC is calculated as a function of the provisional price T_{ABC} of ABC and the final prices of sub-bundles of ABC as follows: P_{ABC}=Min {T_{ABC}, P_{AB}+P_{C}, P_{AC}+P_{B}, P_{BC}+P_{A}}.

In general, if item j is a bundle of k basic products, for arbitrary k, then it can be represented in k different ways as a bundle of two items j1 and j2, where j1 is a basic product and j2 is a bundle of k−1 basic products, where j1 ranges over the k basic products contained in item j. The final price of item j can be calculated as the minimum of Tⱼ and k numbers Pⱼ₁+Pⱼ₂.

As shown by step 506 of FIG. 5, a determination is made as to the provisional winners of each item on the menu. In one embodiment, if the individual participant's bid for an item exceeds the determined price, the bidder is a winner of that item. In one embodiment, for each item, those bidders whose bids for that item exceed the final price of that item are declared provisional winners of that item. In one embodiment, for each bidder i the items that the bidder provisionally won is determined. For bidder i, let J(i) denote the set of items j in J such that i is a member of Wⱼ, the set of provisional winners of item j. Then for each bidder i the item(s) won by bidder i is determined by performing the following calculation: K(i)=Item awarded to bidder i=Arg max_{(j in J(i))} {Vᵢⱼ×Pⱼ}

As shown by step 507 of FIG. 5, each of the provisional winners is allowed to buy an item that the provisional winner has won at the determined price for that item. Thus, the price paid by bidder i is P_{K(i).} In one embodiment each provisional winner can buy only one item. However, alternatively, provisional winners could be allowed to buy more than one item.

As shown by step 508 of FIG. 5 an estimate of the demand system for the items is determined. In the present embodiment, all of the winning bids are used to determine the demand system. However, alternatively, all received bids could be used. In the present embodiment, the demand system for each item is determined in the same manner as in step 305 of FIG. 3 using the bids received in step 504.

In the alternative valuation elicitation method 500, because the price paid by each winning participant is not dependent on the participant's bid, the participant is encouraged to submit the participant's true valuation as a bid. Therefore, the resulting demand system accurately represents the demand for the products and bundles of products.

The preferred embodiment of the present invention is thus described. While the present invention has been described in particular embodiments, it should be appreciated that the present invention should not be construed as limited by such embodiments, but rather construed according to the below claims.

What is claimed is:

1. A method for optimal product bundling and design comprising:
receiving user input indicating a plurality of items;
selecting participants;
configuring an auction structure, said auction structure configured for determining demand complementarities of said items;
conducting an auction using said participants and using said auction structure so as to obtain bid data for said items; and
analyzing said bid data to determine an estimate of a demand system for said items.

2. A method as recited in claim 1 wherein said auction comprises a price equals highest rejected bid auction.

3. A method as recited in claim 2 wherein nonparametric methods are used for determining said estimate of a demand system such that said estimate of said demand system provides a nonparametric estimation of demand complementarities for said items.

4. A method as recited in claim 3 wherein said items comprise a first product, a second product and a bundle that includes said first product and said second product, said estimate of said demand system indicating the structure of demand complementarities for said first product and for said second product and for said bundle.

5. A method as recited in claim 4 further comprising:
determining a set of products and bundle prices that maximizes expected profit.

6. A method as recited in claim 5 further comprising:
determining whether said first product and said second product should be bundled to maximize profit.

7. A method as recited in claim 2 wherein said items include a first product having a first set of attributes and a second product having a second set of attributes, said estimate of said demand system indicating the structure of said demand complementarities for said first set of attributes and for said second set of attributes.

8. A method as recited in claim 3 wherein each of said items is a product having a product configuration that includes attributes, said method further comprising:
determining a profit-maximizing portfolio of product configurations.

9. A method as recited in claim 8 further comprising:
determining prices for each of said product configurations in said profit-maximizing portfolio.

10. A method as recited in claim 1 wherein an auction site is generated that is accessible to said participants and wherein said step of conducting at least one auction further comprises conducting said auction through communication between said participants and said auction site.

11. A method for optimal product bundling and design comprising:
receiving user input indicating a plurality of items and indicating a range for valuations for each of said items;
selecting participants;
indicating to said participants said items;
receiving bids from said participants, said bids indicating a valuation for each of said items;
determining a price for each of said items using a randomly generated number that is within said range for valuations for said item;
determining which of said participants are provisional winners of each of said items using said determined prices for each of said items, each of said provisional winners allowed to purchase one of said items at said determined price for said item; and
analyzing said received bids to determine an estimate of a demand system for said items.

12. A method as recited in claim 11 wherein indicating to said participants said items further comprises sending a communication to each of said participants that includes a web page that indicates a menu of items.

13. A method as recited in claim 11 wherein nonparametric methods are used for determining said estimate of said demand system such that said estimate of said demand system provides a nonparametric estimation of demand complementarities for said items.

14. A method as recited in claim 13 wherein said items comprise a first product, a second product and a bundle that includes said first product and said second product, said estimate of said demand system indicating the structure of demand complementarities for said first product and for said second product and for said bundle.

15. A method as recited in claim 14 further comprising:
determining whether said first product and said second product should be bundled to maximize profit.

16. A method as recited in claim 14 further comprising:
determining prices for said first product and for said second product and for said bundle that maximize profit.

17. A method as recited in claim 11 wherein each of said items is a product having a product configuration that includes attributes, said method further comprising:
determining a profit-maximizing portfolio of product configurations; and
determining prices for each of said product configurations in said profit-maximizing portfolio.

18. In a computer system having a processor coupled to a bus, a computer-readable medium coupled to said bus and having stored therein a computer program that when executed by said processor causes said computer system to implement a method for optimal product bundling and design comprising:
receiving user input indicating a plurality of items;
selecting participants;
determining an auction structure, said auction structure configured for determining demand complementarities of said items;
conducting an auction using said participants and using said auction structure so as to obtain bid data for each of said items; and
determining an estimate of a demand system for said items using said bid data.

19. A computer-readable media as recited in claim 18 wherein said auction comprises a price equals highest rejected bid auction.

20. A computer-readable media as recited in claim 19 wherein nonparametric methods are used for determining said estimate of said demand system such that said estimate of said demand system provides a nonparametric estimation of demand complementarities.

21. A computer-readable media as recited in claim 19 wherein said complementary items include a first product having a first set of attributes and a second product having a second set of attributes, said estimate of said demand system indicating the structure of said demand complementarities for said first set of attributes and for said second set of attributes.

22. In a computer system having a processor coupled to a bus, a computer-readable medium coupled to said bus and having stored therein a computer program that when executed by said processor causes said computer system to implement a method for optimal product bundling and design comprising:
receiving user input indicating a plurality of items and indicating a range for valuations for each of said items;
selecting participants;
indicating to said participants said items;
receiving bids from said participants, said bids indicating a valuation for each of said items;
determining a price for each of said items using a randomly generated number that is within said range for valuation for said item;
determining which of said participants are provisional winners of each of said items using said determined prices for each of said items that are within said range for valuations for each of said items, each of said provisional winners allowed to purchase one of said items at said determined price for said item; and
determining an estimate of a demand system for said items using said received bids.

23. A computer-readable media as recited in claim 22 wherein nonparametric methods are used for determining said estimate of said demand system such that said estimate of said demand system provides a nonparametric estimation of demand complementarities.

24. A computer-readable media as recited in claim 22 wherein said items comprise a first product, a second product and a bundle that includes said first product and said second product, said estimate of said demand system indicating the structure of demand complementarities for said first product and for said second product and for said bundle.

25. A computing device operable to generate a web site, said computing device coupled to the Internet for communicating with participants for conducting auctions for items that have demand systems that include demand complementarities, said computing device operable to use bid data from said auctions for nonparametrically estimating said demand system for said items.

26. The computing device of claim 25 wherein said auctions are price equals highest rejected bid auctions.

27. A computing device operable to generate a web site, said computing device coupled to the Internet for communicating with participants for receiving bids that indicate a valuation for items having said demand system that includes demand complementarities, said computing device operable for nonparametrically estimating said demand system using said bid data.

28. The computing device of claim 27 further comprising a software program operable to nonparametrically estimate said demand system using said bid data.
